(19) United States
(12) Patent Application Publication
(10) Pub. No.: US 2017/0184259 A1
(43) Pub. Date: Jun. 29, 2017

(54) HEADLAMP

(71) Applicant: WENJIE LI, GUANGZHOU (CN)

(72) Inventor: WENJIE LI, GUANGZHOU (CN)

(21) Appl. No.: 15/006,589

(22) Filed: Jan. 26, 2016

(30) Foreign Application Priority Data
Dec. 25, 2015 (CN) 201511003111.9

(51) Int. Cl. F21L 4/08; F21V 31/00; F21V 21/084; F21V 23/06

(52) U.S. Cl. CPC F21L 4/08; F21V 23/06; F21V 31/005; F21V 21/084; F21Y 2115/10

(57) ABSTRACT

A headlamp, including a light source module and a lithium polymer battery in integrated connection is provided. The light source module comprises a circuit board, and the lithium polymer battery connects to the light source module and provides power for the circuit board. Compared with the known art, the present invention is able to be disposed at the forehead position as an integrated part through connecting the lightweight lithium polymer battery in small size with the light source module, which lowers the complexity of the electric circuit and the cost.

### CROSS-REFERENCE TO RELATED APPLICATIONS

This application claims priority to CN 201511003111.9, having a filing date of Dec. 25, 2015, the entire contents of which are hereby incorporated by reference.

### FIELD OF TECHNOLOGY

The following relates to a field of lamps for illumination, in particular to a headlamp.

### BACKGROUND

As a tool for illumination in the dark, headlamp is widely used in outdoor activities such as walking or camping at night for it can be directly worn on the head or the safety helmet keeping the hands free. The existing headlamps comprise a light source module for illumination and a battery for power supplement to the light source module. As these headlamps usually employ NI-MH batteries or alkaline batteries with relatively large volume, the battery and the light source module are usually designed in the separated two parts, so as to reduce the burden of the forehead, i.e. the light source module is fixed on the forehead while the battery is fixed on the occiput and these two parts are connected by wires. However, this separated design increases both the complexity of the design of electric circuit and the cost of design. In addition, when the battery runs out of power, it needs to be drawn out from the headlamp and charged with an appropriate charger, and then installed into the lamp base again, which is very inconvenient.

### SUMMARY

An aspect relates to a headlamp simple in design, cost-saving and convenient for power charging.

Embodiments of the present invention employ the following technical solution: A headlamp, comprising a light source module and a lithium polymer battery in integrated connection, wherein the light source module comprises a circuit board, wherein the lithium polymer battery connects to the circuit board and provides power for the circuit board.

Compared with the known art, embodiments of the present invention are able to be disposed at the forehead position as an integrated part through connecting the lightweight lithium polymer battery in small size with the light source module, which lowers the complexity of the electric circuit and the cost.

Further, the circuit board has a direct built-in Micro-USB port, through which the external power supply can provide power for the lithium polymer battery.

Further, the light source module further comprises a reflection cup, a waterproof ring and a lens, wherein an LED emitter is fixed on the circuit board, the said reflection cup is arranged to enclose the LED emitter, and the said lens is fixed on the surface of the reflection cup through the waterproof ring.

Further, the light source module further comprises a front housing, a back housing and a holder, wherein the said circuit board, reflection cup, waterproof ring and the lens are arranged inside the front housing, wherein the back housing covers the circuit board and forms a confined space with the said front housing, wherein the back housing is fixed on the holder with together with the front housing as an integrated part.

Further, the light source module further comprises a waterproof cover, wherein the said waterproof cover is fixed on the bottom of the front housing and covers the direct built-in Micro-USB port.

Further, the light source module further comprises a button holder, a button and a button cap, wherein the button holder is arranged on top of the front housing, wherein the button is fixed on the button holder and connects with the circuit board, wherein the button cap is arranged on and covers the button.

### BRIEF DESCRIPTION

For better understanding and implementation, the present invention will be described in detail with reference to the following drawings:

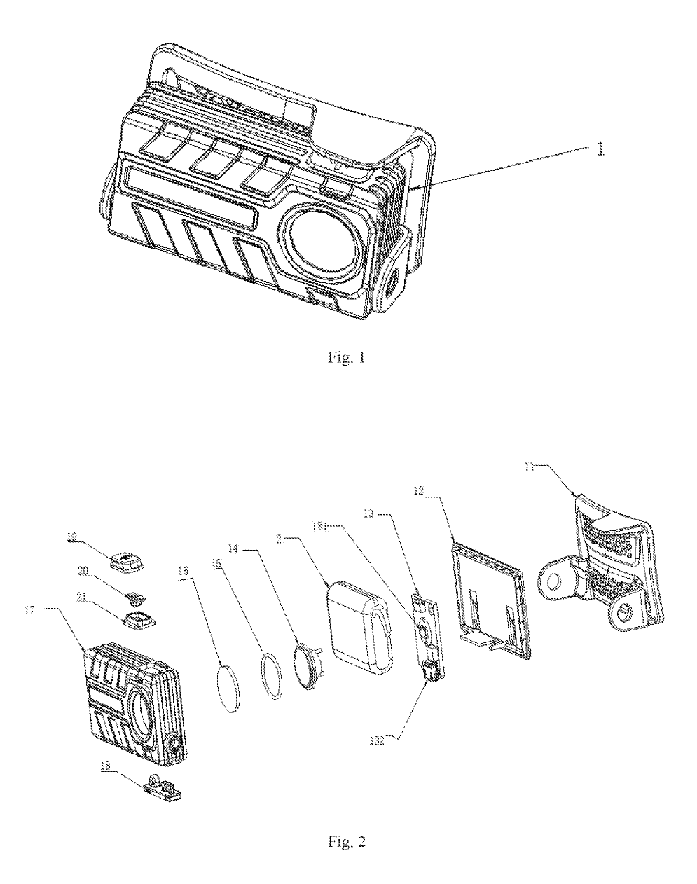

FIG. 1 is an external structure diagram of the headlamp.

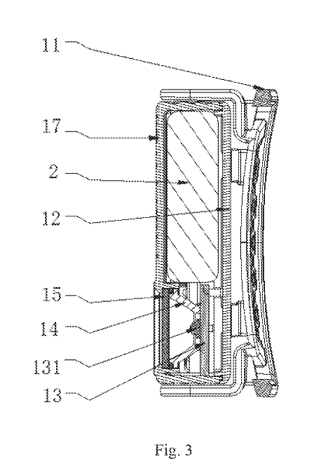

FIG. 2 is an exploded view of the headlamp.

FIG. 3 is a side view of the headlamp.

### DETAILED DESCRIPTION

Referring to FIG. 1, FIG. 2 and FIG. 3, FIG. 1 is an external structure diagram of the headlamp, FIG. 2 is an exploded view of the headlamp, and FIG. 3 is a side view of the headlamp. The head lamp comprises a light source module 1 and a lithium polymer battery 2 in integrated connection.

The light source module 1 comprises a holder 11, a back housing 12, a circuit board 13, a reflection cup 14, a waterproof ring 15, a lens 16 and a front housing 17. The lithium polymer battery 2 connects to the circuit board 13 and provides power for the circuit board 13. An LED emitter 131 is fixed on the circuit board 13, the said reflection cup 14 is arranged to enclose the LED emitter 131, and the said lens 16 is fixed on the surface of the reflection cup 14 through the waterproof ring 15. The circuit board 13, reflection cup 14, waterproof ring 15 and lens 16 are arranged inside the front housing 17. The back housing 12 covers the circuit board 13 and forms a confined space with the said front housing 17. Also, the back housing 12 is fixed on the holder 11 with together with the front housing 17 as an integrated part.

The circuit board 13 has a direct built-in Micro-USB port 132, through which the external power supply can provide power for the lithium polymer battery 2.

In order to prevent water ingress through the direct built-in Micro-USB port 132 damaging the said circuit board 13, the light source module 1 further comprises a waterproof cover 18; the said waterproof cover 18 is fixed on the bottom of the front housing 17 and covers the direct built-in Micro-USB port 132.

The light source module 1 further comprises a button cap 19, a button 20 and a button holder 21, wherein the button holder 21 is arranged on top of the front housing 17, wherein the button 20 is fixed on the button holder 21 and connects with the circuit board 13, wherein the button cap 19 is arranged on and covers the button 20.

Compared with the existing NI-MH battery or alkaline battery, the said lithium polymer battery 2 is of higher energy density, i.e. having a smaller volume when storing the same energy. In addition, shape of this battery can be customized according to the needs, which is able to be conveniently arranged at the forehead.

Compared with the prior art, embodiments of the present invention are able to be disposed at the forehead position as an integrated part through connecting the lightweight lithium polymer battery in small size with the light source module, which lowers the complexity of the electric circuit and the cost. Moreover, the external power source can charge the lithium polymer battery through the common direct built-in Micro-USB port. By this means, the battery no longer needs to be drawn out for charging or charged by exclusive charger, which is much more convenient and time-saving.

Embodiments of the present invention are not limited in the above embodiment. All modifications and changes of embodiments of the present invention made on the basis of the spirit or scope of embodiments of the present invention shall fall within the protective scope of the claims of embodiments of the present invention.

What is claimed is:

1. A headlamp comprising: a light source module and a lithium polymer battery in integrated connection; wherein the light source module comprises a circuit board; wherein the lithium polymer battery connects to the circuit board and provides power for the circuit board.

2. The headlamp of claim 1, wherein the circuit board has a direct built-in Micro-USB port, through which the external power supply can provide power for the lithium polymer battery.

3. The headlamp of claim 2, wherein the light source module further comprises a reflection cup, a waterproof ring and a lens, wherein an LED emitter is fixed on the circuit board, the said reflection cup is arranged to enclose the LED emitter, and the said lens is fixed on the surface of the reflection cup through the waterproof ring.

4. The headlamp of claim 3, wherein the light source module further comprises a front housing, a back housing and a holder, wherein the said circuit board, reflection cup, waterproof ring and lens are arranged inside the front housing, wherein the back housing covers the circuit board and forms a confined space with the said front housing, and wherein the back housing is fixed on the holder together with the front housing as an integrated part.

5. The headlamp of claim 4, wherein the light source module further comprises a waterproof cover, the said waterproof cover is fixed on the bottom of the front housing and covers the direct built-in Micro-USB port.

6. The headlamp of claim 5, wherein the light source module further comprises a button holder, a button and a button cap, wherein the button holder is arranged on top of the front housing, wherein the button is fixed on the button holder and connects with the circuit board, wherein the button cap is arranged on and covers the button.
